(19) United States
(12) Patent Application Publication
(10) Pub. No.: US 2025/0312747 A1
(43) Pub. Date: Oct. 9, 2025

(54) Solute Crystal Generating Reverse Osmosis Systems and Methods

(71) Applicant: The Regents of the University of Colorado, a body corporate, Denver, CO (US)

(72) Inventor: John PELLEGRINO, Boulder, CO (US)

(21) Appl. No.: 18/865,297

(22) PCT Filed: May 12, 2023
(86) PCT No.: PCT/US2023/066962

§ 371 Date: Nov. 12, 2024

Related U.S. Application Data
(60) Provisional application No. 63/341,865, filed on May 13, 2022.

(51) Int. Cl. B01D 65/08; B01D 61/02; B01D 61/12

(52) U.S. Cl. CPC B01D 65/08; B01D 61/025; B01D 61/12

(57) ABSTRACT

The presently disclosed technology is directed to systems and methods of separating a solvent in a solution from a solute in the solution by introducing the solution to a separation vessel including an adhesion-resistant membrane adapted to selectively allow the solvent to permeate through the adhesion-resistant membrane without the solute, moving the solvent of the solution from a first side of the adhesion-resistant membrane to a second side of the adhesion-resistant membrane, wherein fluid communication between the first side and the second side is through the adhesion-resistant membrane, saturating the solute on the first side to form a supersaturated solution, and maintaining the supersaturated solution in the vessel for a predetermined time to nucleate crystals of the solute to satisfy a crystallization condition.

### CROSS-REFERENCE TO RELATED APPLICATIONS

The present application claims priority to U.S. Provisional Application No. 63/341,865, filed May 13, 2022, and entitled “Solute Crystal Generating Reverse Osmosis System”, the entirety of which is hereby incorporated by reference.

### BACKGROUND

In separation operations that use membranes to remove species, the performance of the membranes can suffer from scaling that aggregates and reduces or prevents fluid transfer through the membranes. In reverse osmosis (RO) applications (e.g., desalination), many of the resident chemicals, such as sparingly soluble species in water from natural sources, form crystals under certain conditions. Such crystal formation can significantly reduce the lifetime of the membranes if the crystals deposit and adhere to the membrane's surfaces. The adhesion of crystals on the membrane surface can cause scaling, which may require the introduction of chemicals to remove or may require more frequent replacement of the membranes.

In industry, conditions may be controlled to prevent crystal growth within RO equipment. However, some separation process may benefit from crystal production, as crystallized materials are less costly to separate from the fluid than dissolved materials, thus making the prevention of crystal formation undesirable. Industrial processes can also include the introduction of chemicals to prevent crystal formation. In addition to preventing the possible desirable formation of crystals mentioned previously, another issue with introducing chemicals to prevent crystal formation is that the chemicals have to be subsequently removed, thus requiring another potentially costly separation operation.

Accordingly, a need exists for membrane separation technologies that may still permit crystallization, but which do not suffer from the adhesion of crystal to the membrane surfaces.

### SUMMARY

The disclosed technology is directed to systems and methods for separating a solvent in a solution from a solute in the solution by introducing the solution to a separation vessel including an adhesion-resistant membrane adapted to selectively allow the solvent to permeate through the adhesion-resistant membrane without the solute, moving the solvent of the solution from a first side of the adhesion-resistant membrane to a second side of the adhesion-resistant membrane, wherein fluid communication between the first side and the second side is through the adhesion-resistant membrane, saturating the solute on the first side to form a supersaturated solution, and maintaining the supersaturated solution in the vessel for a determined time to thereby nucleate crystals of the solute to satisfy a crystal concentration condition.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates a system for separating a solvent in a solution from a solute in the solution.

FIG. 2 illustrates example operations for separating a solvent in a solution from a solute in the solution.

### DETAILED DESCRIPTIONS

The presently disclosed technology encourages crystal formation within separation equipment such as reverse osmosis (RO) equipment. Encouraging crystal formation within the equipment allows for quicker and cheaper separation operations that benefit from the crystallization and from an absence of chemicals that prevent the crystallization. In an implementation, an separation system includes a separation membrane adapted to resist the adhesion of solutes (such as sparingly soluble species) to the separation membrane. The resistance to adhesion allows the crystallization to occur within the vessel without the concern that the membrane will lose permeability due to blockages caused by crystalized solute adhered to the membrane. With these features, a separation system, such as a reverse osmosis system, can eschew the use of chemicals that discourage crystallization, and the downstream processes for separating the crystallized materials are simplified. Additionally, more permeate may be generated per unit of solution introduced in a feed.

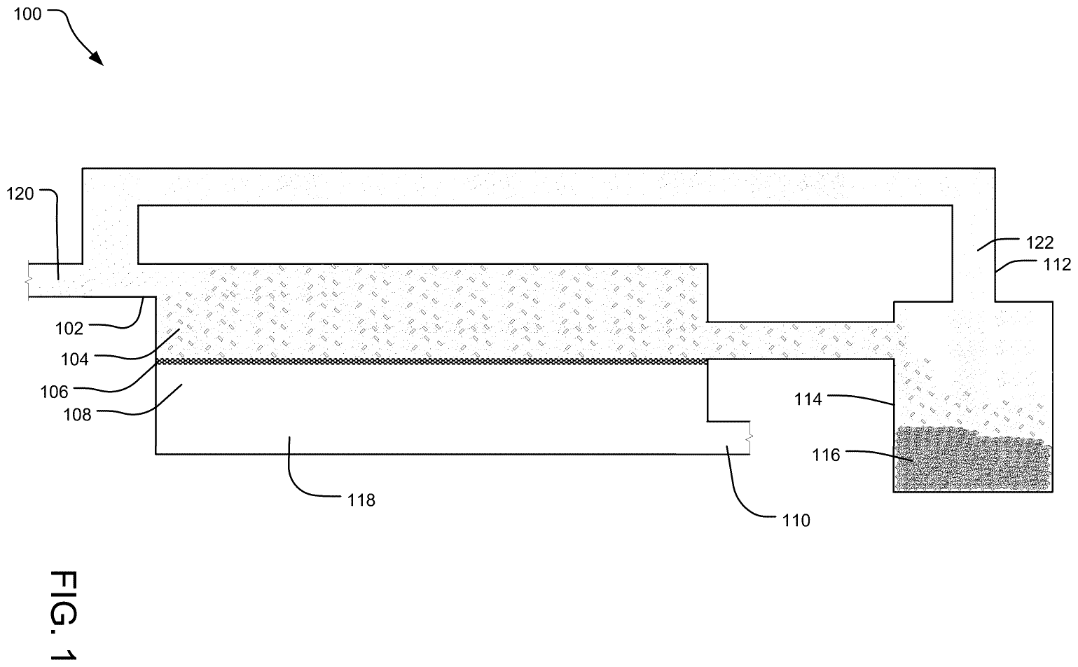

FIG. 1 illustrates a system 100 for separating a solvent in a solution from a solute in the solution. In some implementations, the system 100 is a reverse osmosis separation system, though other separation systems can employ the technology described herein. In the system 100, a feed solution 120 is provided to a feed 102 of a first separation vessel 104. The first separation vessel 104 includes an adhesion-resistant membrane 106 with a first side 126 and a second side 108. In the illustrated configuration, the first separation vessel 104 is partitioned by the adhesion-resistant membrane 106 such that the solvent of the solution selectively permeates from the first side 126 to the second side 108 as permeate 118. The adhesion-resistant membrane 106 prevents the solute from permeating from the first side 126 to the second side 108. The selective removal of the solvent from the feed solution 120 causes the solute to accumulate on the first side 126 to generate a supersaturated solution 124. In implementations, the solute in the supersaturated solution 124 forms crystals given appropriate conditions for crystal formation. Examples of solutes include sparingly soluble species such as calcium carbonate, calcium sulfate, and other sparingly soluble salts.

Flow properties within the first separation vessel 104 can be controlled by, without limitation, one or more of the geometry of the interior of the first separation vessel 104, pressure applied or flow rate resulting from pump pressures applied to the feed solution 120 to the first separation vessel 104, active or passive mixing in the first separation vessel 104, chemical properties of the adhesion-resistant membrane 106, and/or patterns of embossing and/or etching on a surface 128 of the adhesion-resistant membrane 106.

The flow rate of the feed solution 120 may be controlled by a pump (not illustrated) to provide pressure to the feed solution 120 entering the first separation vessel 104. The pressure exerted may overcome the osmotic pressure exerted from the first side 126 to the second side 108 by the concentration gradient to compel the solvent through the adhesion-resistant membrane 106 to the second side 108. The flow rate may be controlled (e.g., by a controller not illustrated) to be maintained within a predetermined flow rate or predetermined flow rate range. The predetermined flow rate may be selected to maintain the supersaturated solution 124 for a predetermined time. The predetermined time may be experimentally determined to be operative to allow crystals of the solute to form within the first separation vessel 104. The predetermined time may be determined to maintain the supersaturated solution 124 on the first side 126 in the first separation vessel 104 such that the supersaturated solution 124 formed satisfies a crystallization condition.

In implementations, the system 100 includes mixing elements (not illustrated) that actively (e.g., by mechanical motion of the mixer) or passively mix the feed solution 120 and/or the supersaturated solution 124. The mixing may also modify the solute crystallization properties including by modifying a mixing property such as a Kolmogorov mixing length of the feed solution 120 and/or the supersaturated solution 124. The mixing may be conducted in a predetermined manner. For example, at the time of manufacture, passive mixers can be arranged to modify mixing properties based on the flow rate and geometry of elements in the first separation vessel 104. At the time of operation, an active mixer can be operated to actively modify mixing actuation and/or modify a position or orientation of the active mixers either in the feed 102 or in the first separation vessel 104. The mixing parameters can be modified alone or in conjunction with the flow rate to modify the supersaturated solution 124 in the first separation vessel 104 to satisfy the crystallization condition.

The crystallization condition may be based on a threshold value or a range of values of one or more of crystal concentration, crystal size, other crystal geometry, Kolmogorov mixing length, a Reynolds number for flow in the first separation vessel 104, a feed flow rate, a pressure inside the first separation vessel 104, a temperature of a solution (e.g., one or more of the feed solution 120, the supersaturated solution 124 and/or a recycle solution 122), a solute concentration (e.g., of one or more of the feed solution 120, the supersaturated solution 124 and/or the recycle solution 122 concentration), two-phase flow induced by dearation (e.g., bubbles formed by pressure changes in flow), and the like.

The system 100 may be specifically configured to encourage solute crystallization in the first separation vessel 104 because the adhesion-resistant membrane 106 is adapted to prevent the crystallized solute from adhering to a surface 128 of the adhesion-resistant membrane 106 exposed to the first side 124. In implementations, the surface adhesion-resistant properties can be manipulated by manipulating the chemistry of the surface 128. Hydroxide functional groups and acetyl functional groups may help to prevent adhesion. In an implementation, the surface 128 includes a predefined concentration of one or more of hydroxide functional groups and acetyl functional groups. Other materials contemplated to introduce to the surface 128 to modify the properties of the surface 128 include polyethylene glycol, graphene oxide, zwitterionic compounds, other hydrophilic compounds, mono-fluorinated trimesyl chloride, m-phenylamine diamine-trimesoyl chloride, polyamide thin-film composite, tetrafluoroethylene, polytetrafluoroethylene, and the like.

In implementations, the surface adhesion-resistant properties of the surface 128 can be manipulated by manipulating the geometry of the surface 128. For example, the surface 128 may include an embossed and/or etched pattern in the surface. The adhesion properties of the surface 128 can be modified by modifying one or more of the pattern shapes, the pattern sizes, the magnitude of the distance between embossed or etched elements, and the depth or height of the embossed and/or etched elements relative to other positions on the surface 128.

In an implementation, the system 100 may include one or more sensors (not illustrated). For example, one sensor could be operable to detect (e.g., measure) a solution property of one or more of the feed solution 120, the supersaturated solution 124, and recycled solution 122 from a recycling feed 112. The detected (e.g., measured) solution properties can include values of one or more of crystal concentration, crystal size, other crystal geometry, a feed flow rate, pressure inside the first separation vessel 104, temperature of a solution (e.g., one or more of the feed solution 120, the supersaturated solution 124 and/or a recycle solution 122), solute concentration of the solution, flocculence of the solution, opacity of the solution, and the like. The detected solution properties can be used in a feedback loop to inform one or more of a predefined flow rate, a predetermined manner of mixing, and satisfaction of a crystallization condition.

In some embodiments, the supersaturated solution 124 is fed to a second separation vessel 114. In an implementation, a pump provides pressure between the first separation vessel 104 and the second separation vessel 114. The supersaturated solution 124 has already crystallized to a predefined degree (e.g., in satisfaction of a crystallization condition) in the first separation vessel 104. Unlike reverse osmosis systems in which an objective is to avoid solute crystallization in vessels with membranes or upstream of vessels with membranes, the system 100 has promoted crystal formation in the first separation vessel 104 with the adhesion-resistant membrane 106. The system 100 relies on the adhesion-resistant membrane 106 and the flow properties of the interior of the first separation vessel 104 to nucleate solute crystals within the interior of the first separation vessel 104 that are easier to separate in the second separation vessel 114.

As illustrated, crystals 116 are deposited at the bottom of the second separation vessel 114 to form a desupersaturated solution 122. The concentration of the solute in the desupersaturated solution 122 may be greater than, less than, or substantially the same as that of the feed solution 120. The desupersaturated solution is recycled in a recycle feed 122 to the source feed 120.

The permeate 118 on the second side 108 of the adhesion-resistant membrane 106 is fed to a permeate outlet 110 which may transfer the permeate to a different vessel (not illustrated) or pipeline (not illustrated).

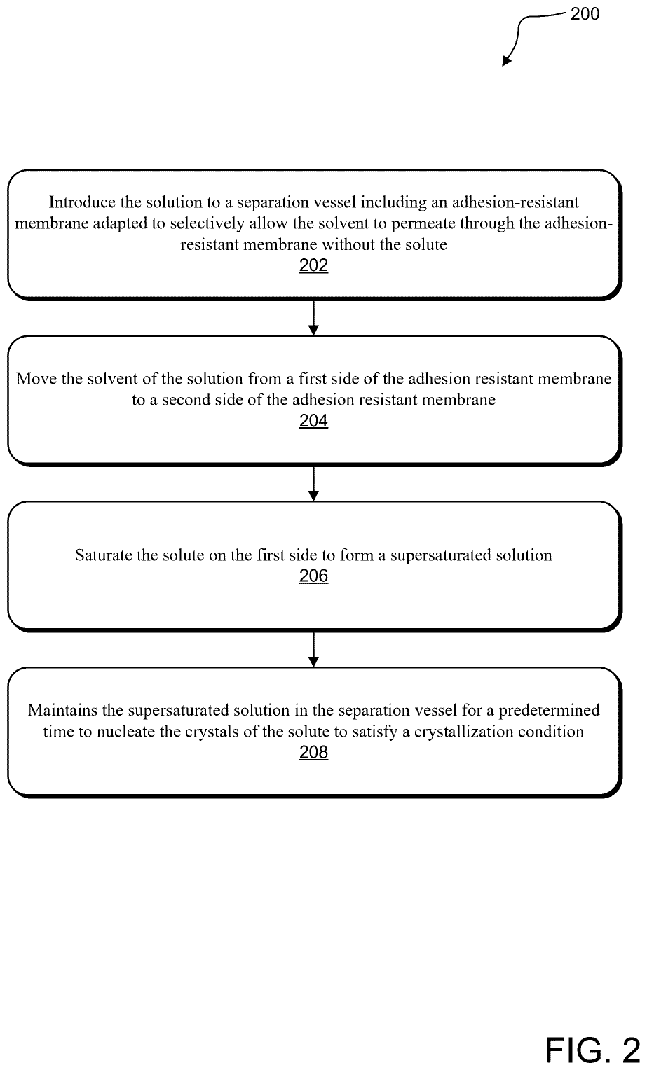

FIG. 2 illustrates example operations 200 for separating a solvent in a solution from a solute in the solution. An introducing operation 202 introduces the solution to a separation vessel, including an adhesion-resistant membrane adapted to selectively allow the solvent to permeate through the adhesion-resistant membrane without the solute.

A moving operation 204 moves the solvent of the solution from a first side of the adhesion-resistant membrane to a second side of the adhesion-resistant membrane. In an implementation, the fluid communication between the first side and the second side is through the adhesion-resistant membrane (e.g., exclusively such that the solution cannot pass around the filter to the second side).

A saturating operation 206 saturates the solute on the first side to form a supersaturated solution.

A maintaining operation 208 maintains the supersaturated solution in the separation vessel for a predetermined time to nucleate the crystals of the solute to satisfy a crystallization condition.

In implementations, the operations 200 may further include a controlling operation (not illustrated) that controls a flow rate of the solution into the vessel to maintain the flow rate within a predetermined flow rate range. In implementations, the operations 200 may further include a mixing operation (not illustrated) that mixes the solution in the vessel to maintain a predetermined Kolmogorov length in the separation vessel. In implementations, the operations further include a sensing operation (not illustrated) that measures a solution property such as a concentration of the solute in the introduced solution, wherein the predetermined time is dynamic and based on the measured concentration. In implementations, the operations 200 may further include a sensing operation (not illustrated) that measures a solution property such as the concentration of the solute in the supersaturated solution, wherein the predetermined time is dynamic and based on the measured concentration. In implementations, the operations 200 may further include a removing operation (not illustrated) that removes the filtered solvent to a recovery vessel and/or a removing operation (not illustrated) that removes the supersaturated solution to a third vessel, where the recovery vessel and the third vessel are not in fluid communication except via the first separation vessel. In implementations, the operations 200 may further include a separating operation (not illustrated) that separates crystallized portions of the solute in the recovery vessel to form a desupersaturated solution and/or a removing operation that removes the desupersaturated solution from the third vessel to the separation vessel.

In implementations, the solute is a sparingly soluble species and the adhesion-resistant membrane is configured to resist adhesion of the crystallized sparingly soluble species. In implementations, the sparingly soluble species is a calcium salt. In implementations, the adhesion-resistant membrane includes a surface exposed to the first side, the surface including a predefined minimum concentration of one or more of hydroxyl functional groups, carboxyl functional groups, and other hydrophilic functional groups per unit surface area of the surface. In implementations, the adhesion-resistant membrane includes a surface exposed to the first side, the surface including a predefined embossed pattern.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. Nevertheless, it will be understood that various modifications can be made without departing from the spirit and scope of the recited claims.

As used herein, terms such as “substantially,” “about,” “approximately,” or other terms of relative degree are interpreted as a person skilled in the art would interpret the terms and/or amount to a magnitude of variability of one or more of 1%, 2%, 3%, 4%, 5%, 6%, 7%, 8%, 9%, 10%, 11%, 12%, 13%, 14%, or 15% of a metric relative to the quantitative or qualitative feature described. For example, a term of relative degree applied to orthogonality suggests an angle may have a magnitude of variability relative to a right angle. When values are presented herein for particular features and/or a magnitude of variability, ranges above, ranges below, and ranges between the values are contemplated.

What is claimed is:

1. A method for separating a solvent in a solution from a solute in the solution, the method comprising:
introducing the solution to a separation vessel including an adhesion-resistant membrane adapted to selectively allow the solvent to permeate through the adhesion-resistant membrane without the solute;
moving the solvent of the solution from a first side of the adhesion-resistant membrane to a second side of the adhesion-resistant membrane, wherein fluid communication between the first side and the second side is through the adhesion-resistant membrane;
saturating the solute on the first side of the adhesion-resistant membrane to form a supersaturated solution on the first side of the adhesion resistant membrane; and
maintaining the supersaturated solution in the separation vessel on the first side of the adhesion-resistant membrane for a period of time to thereby nucleate crystals of the solute to satisfy a crystallization condition.

2. The method of claim 1, the method further comprising:
controlling a flow rate of the solution into the separation vessel to maintain the flow rate within a determined flow rate range.

3. The method of claim 1, the method further comprising:
mixing the solution in the separation vessel to maintain a determined Kolmogorov length in the separation vessel.

4. The method of claim 1, the method further comprising:
measuring a concentration of the solute in the introduced solution; and
adjusting the determined time based on the measured concentration.

5. The method of claim 1, the method further comprising:
measuring a concentration of the solute in the supersaturated solution; and
adjusting the determined time based on the measured concentration.

6. The method of claim 1, wherein the solute is a sparingly soluble species and the adhesion-resistant membrane is configured to resist adhesion of crystallized sparingly soluble species.

7. The method of claim 6, wherein the sparingly soluble species is a calcium salt.

8. The method of claim 1, wherein a surface of the first side of the adhesion-resistant membrane includes a concentration of one or more of hydroxyl functional groups and carboxyl functional groups per unit surface area of the surface.

9. The method of claim 1, the method further comprising:
removing the moved solvent to a recovery vessel; and
removing the supersaturated solution to a third vessel, wherein the recovery vessel and the third vessel are fluidly separated from each other except via the separation vessel.

10. The method of claim 9, the method further comprising:
separating crystallized solute in the recovery vessel to generate a desupersaturated solution; and
transferring the desupersaturated solution from the third vessel to the separation vessel.

11. The method of claim 1, wherein a surface of the first side of the adhesion-resistant membrane includes a predefined embossed pattern.

12. A system for separating a solvent in a solution from a solute in the solution, the system comprising:
a first adhesion-resistant membrane, the first adhesion-resistant membrane including a first side and a second side and adapted to selectively allow the solvent to permeate through the first adhesion-resistant membrane without the solute, leaving a supersaturated solution on the first side of the first adhesion-resistant membrane, and further adapted to prevent crystalized solute from adhering to the first side of the first adhesion-resistant membrane when crystalized solute is formed in the supersaturated solution.

13. The system of claim 11, further comprising:
a separation vessel, wherein the first adhesion-resistant membrane is positioned in the separation vessel to allow permeate to permeate through the adhesion-resistant membrane and prevent the solute from permeating to the second side of the first adhesion-resistant membrane in the separation vessel;
a pump configured to apply pressure to the solution to provide a flow rate of the solution to the separation vessel, wherein the flow rate maintains the supersaturated solution in the separation vessel for a determined time to form crystals of solute to satisfy a crystallization condition; and
a mixing element configured to mix the solution to provide a predefined Kolmogorov mixing length to promote crystallization in the separation vessel.

14. The system of claim 13, further comprising:
a second adhesion-resistant membrane adjacent to the first adhesion-resistant membrane; and
at least one spacer positioned between the first adhesion-resistant membrane and the second adhesion-resistant membrane.

15. The system of claim 13, further comprising:
a sensor operable to detect a concentration of the solute in a feed of the solution to the separation vessel, wherein the determined time adjusted based on the detected concentration.

16. The system of claim 13, further comprising:
a sensor operable to detect a concentration of the solute in the supersaturated solution in the separation vessel, wherein the determined time is adjusted based on the detected concentration.

17. The system of claim 13, further comprising:
a recovery vessel adapted to receive the permeated solvent; and
a third vessel adapted to receive the supersaturated solution, wherein the recovery vessel and the third vessel are fluidly separated except via the first separation vessel.

18. The system of claim 11, wherein the solute is a sparingly soluble species and the first adhesion-resistant membrane is configured to resist adhesion of the crystallized sparingly soluble species to the first adhesion-resistant membrane.

19. The system of claim 11, wherein a surface of the first side of the first adhesion-resistant membrane includes a concentration of one or more of hydroxyl functional groups and carboxyl functional groups per unit surface area of the surface.

20. The system of claim 11, wherein a surface of the first side of the adhesion-resistant membrane includes a predefined embossed pattern.
